(19) United States
(12) Patent Application Publication
(10) Pub. No.: US 2018/0119000 A1
(43) Pub. Date: May 3, 2018

(54) METHOD FOR HYDROCARBON RECOVERY

(71) Applicant: SHELL OIL COMPANY, Houston, TX (US)

(72) Inventors: Timothy Elton KING, Katy, TX (US); Lori Ann CROM, Houston, TX (US); Julian Richard BARNES, Amsterdam (NL); Paulus Johannes KUNKELER, Rotterdam (NL); Marten Adriaan BUIJSE, Rijswijk (NL); Diederik Willem VAN BATENBURG, Rijswijk (NL)

(21) Appl. No.: 15/856,157

(22) Filed: Dec. 28, 2017

(51) Int. Cl. C09K 8/58

(52) U.S. Cl. CPC C09K 8/58

(57) ABSTRACT

The invention relates to a method of treating a hydrocarbon containing formation comprising providing a hydrocarbon recovery composition to at least a portion of the hydrocarbon containing formation and allowing the hydrocarbon recovery composition to contact the formation wherein the hydrocarbon recovery composition comprises an alcohol alkoxy sulfate and an internal olefin sulfonate.

### FIELD OF THE INVENTION

The present invention relates to a method of recovering hydrocarbons from a hydrocarbon formation.

### BACKGROUND OF THE INVENTION

Hydrocarbons, such as oil, may be recovered from hydrocarbon containing formations (or reservoirs) by penetrating the formation with one or more wells, which may allow the hydrocarbons to flow to the surface. A hydrocarbon containing formation may have one or more natural components that may aid in mobilising hydrocarbons to the surface of the wells. For example, gas may be present in the formation at sufficient levels to exert pressure on the hydrocarbons to mobilise them to the surface of the production wells. These are examples of so-called “primary oil recovery”.

However, reservoir conditions (for example permeability, hydrocarbon concentration, porosity, temperature, pressure, composition of the rock, concentration of divalent cations (or hardness), etc.) can significantly impact the economic viability of hydrocarbon production from any particular hydrocarbon containing formation.

Furthermore, the above-mentioned natural pressure-providing components may become depleted over time, often long before the majority of hydrocarbons have been extracted from the reservoir. Therefore, supplemental recovery processes may be required and used to continue the recovery of hydrocarbons, such as oil, from the hydrocarbon containing formation. Such supplemental oil recovery is often called “secondary oil recovery” or “tertiary oil recovery”. Examples of known supplemental processes include waterflooding, polymer flooding, gas flooding, alkali flooding, thermal processes, solution flooding, solvent flooding, or combinations thereof. Various surfactants may be used in these supplemental processes, but some surfactants are less effective under certain reservoir conditions.

### SUMMARY OF THE INVENTION

The invention provides a method of treating a hydrocarbon containing formation comprising providing a hydrocarbon recovery composition to at least a portion of the hydrocarbon containing formation and allowing the hydrocarbon recovery composition to contact the formation wherein the hydrocarbon recovery composition comprises an alcohol alkoxy sulfate and an internal olefin sulfonate.

### DETAILED DESCRIPTION OF THE INVENTION

The present invention relates to a hydrocarbon recovery composition comprising one or more internal olefin sulfonates and one or more alcohol alkoxy sulfates. Alkoxylated alcohols may also be referred to as alcohol alkoxylates. In one embodiment, the hydrocarbon recovery composition comprises a mixture of internal olefin sulfonates and alcohol alkoxy sulfates, preferably a mixture of internal olefin sulfonates with alcohol ethoxy sulfates.

In one embodiment, the weight ratio of the alcohol alkoxy sulfate to the internal olefin sulfonate is below 1:1. Preferably, the weight ratio is at least 1:100, more preferably at least 1:50, more preferably at least 1:20 and most preferably at least 1:10. Further, preferably, the weight ratio is at most 1:5.7, more preferably at most 1:4.0, more preferably at most 1:2.3, more preferably at most 1:1.5.

In another embodiment, the weight ratio of the internal olefin sulfonate to the alcohol alkoxy sulfate is below 1:1. Preferably, the weight ratio is at least 1:100, more preferably at least 1:50, more preferably at least 1:20 and most preferably at least 1:10. Further, preferably, the weight ratio is at most 1:5.7, more preferably at most 1:4.0, more preferably at most 1:2.3, more preferably at most 1:1.5.

The hydrocarbon recovery composition preferably contains water. The active matter content of the aqueous hydrocarbon recovery composition is preferably at least 20 wt. %, more preferably at least 40 wt. %, more preferably at least 50 wt. %, most preferably at least 60 wt. %. “Active matter” herein means the total of anionic species in the aqueous composition, but excluding any inorganic anionic species, for example, sodium sulfate. The active matter content concerns the active matter content of the hydrocarbon recovery composition before it may be combined with a hydrocarbon removal fluid, which fluid may comprise water (e.g. a brine), to produce an injectable fluid, which injectable fluid may be injected into a hydrocarbon containing formation.

In general, stability of the hydrocarbon recovery composition components at a high temperature is relevant to prevent the components from being decomposed (for example hydrolyzed) at such high temperature. Internal olefin sulfonates (IOS) are known to be heat stable at temperatures of 60° C. or higher. However, in addition to being heat stable, a hydrocarbon recovery composition may also have to withstand a relatively high concentration of divalent cations. The high concentration of divalent cations may have the effect of precipitating the hydrocarbon recovery composition components out of solution. The hydrocarbon recovery composition should have an adequate aqueous solubility as that improves the injectability of the fluid comprising the hydrocarbon recovery composition to be injected into the hydrocarbon containing formation. Further, an adequate aqueous solubility reduces loss of the components through adsorption to rock or surfactant retention as trapped, viscous phases within the hydrocarbon containing formation. Precipitated solutions would not be suitable as they could result in formation plugging.

The hydrocarbon recovery composition comprises an internal olefin sulfonate which comprises internal olefin sulfonate molecules. An internal olefin sulfonate molecule is an alkene or hydroxyalkane which contains one or more sulfonate groups. Examples of such internal olefin sulfonate molecules are hydroxy alkane sulfonates (HAS) and alkene sulfonates (OS).

The internal olefin sulfonate (IOS) is prepared from an internal olefin by sulfonation. An internal olefin and an IOS comprise a mixture of internal olefin molecules and a mixture of IOS molecules, respectively. The molecules differ from each other, for example, in terms of carbon number and/or branching degree.

Branched IOS molecules are IOS molecules derived from internal olefin molecules which comprise one or more branches. Linear IOS molecules are IOS molecules derived from internal olefin molecules which are linear. An internal olefin may be a mixture of linear internal olefin molecules and branched internal olefin molecules. Analogously, an IOS may be a mixture of linear IOS molecules and branched IOS molecules. An internal olefin or IOS may be characterized by its carbon number and/or linearity.

An internal olefin or internal olefin sulfonate mixture may be characterized by its average carbon number. The average carbon number is determined by multiplying the number of carbon atoms of each molecule by the weight fraction of that molecule and then adding the products, resulting in a weight average carbon number. The average carbon number may be determined by gas chromatography ((GC) analysis of the internal olefin.

Linearity is determined by dividing the weight of linear molecules by the total weight of branched, linear and cyclic molecules. Substituents (like the sulfonate group and optional hydroxy group in the internal olefin sulfonates) on the carbon chain are not seen as branches. The linearity may be determined by gas chromatography (GC) analysis of the internal olefin.

Within the present specification, “branching index” (BI) refers to the average number of branches per molecule, which may be determined by dividing the total number of branches by the total number of molecules. The branching index may be determined by ¹H-NMR analysis.

When the branching index is determined by analysis, the total number of branches equals: [total number of branches on olefinic carbon atoms (olefinic branches)]+[total number of branches on aliphatic carbon atoms (aliphatic branches)]. The total number of aliphatic branches equals the number of methine groups, which latter groups are of formula R₃CH wherein R is an alkyl group. Further, the total number of olefinic branches equals: [number of trisubstituted double bonds]+[number of vinylidene double bonds]+2*[number of tetrasubstituted double bonds]. Formulas for the trisubstituted double bond, vinylidene double bond and tetrasubstituted double bond are shown below. In all of the below formulas, R is an alkyl group.

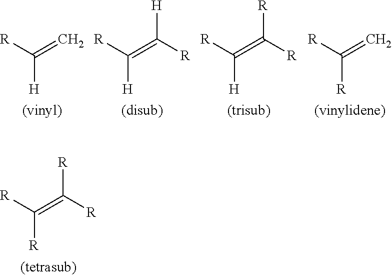

The average molecular weight is determined by multiplying the molecular weight of each surfactant molecule by the weight fraction of that molecule and then adding the products, resulting in a weight average molecular weight.

The foregoing passages regarding (average) carbon number, linearity, branching index and molecular weight apply analogously to the alkoxylated alcohol and/or alkoxylated alcohol derivative as further described below.

The hydrocarbon recovery composition comprises an internal olefin sulfonate (IOS) that is at least 40 wt. % linear, more preferably at least 50 wt. %, more preferably at least 60 wt. %, more preferably at least 70 wt. %, more preferably at least 80 wt. %, most preferably at least 90 wt. % linear. For example, 40 to 100 wt. %, more suitably 50 to 100 wt. %, more suitably 60 to 100 wt. %, more suitably 70 to 99 wt. %, most suitably 80 to 99 wt. % of the IOS may be linear. Branches in the IOS may include methyl, ethyl and/or higher molecular weight branches including propyl branches.

Preferably, the IOS is not substituted by groups other than sulfonate groups and optionally hydroxy groups. The IOS preferably has an average carbon number in the range of from 5 to 40, more preferably 10 to 35, more preferably 15 to 30, most preferably 17 to 28.

In one embodiment the IOS may be selected from the group consisting of C₁₅₋₁₈ IOS, C₁₉₋₂₃ IOS, C₂₀₋₂₄ IOS, C₂₄₋₂₈ IOS and mixtures thereof, wherein “IOS” stands for “internal olefin sulfonate”. Suitable internal olefin sulfonates include those from the ENORDET™ O series of surfactants commercially available from Shell Chemical.

“C₁₅₋₁₈ internal olefin sulfonate” (C₁₅₋₁₈ IOS) as used herein means a mixture of internal olefin sulfonate molecules wherein the mixture has an average carbon number of from 16 to 17 and at least 50% by weight, preferably at least 65% by weight, more preferably at least 75% by weight, most preferably at least 90% by weight, of the internal olefin sulfonate molecules in the mixture contain from 15 to 18 carbon atoms.

“C₁₉₋₂₃ internal olefin sulfonate” (C₁₉₋₂₃ IOS) as used herein means a mixture of internal olefin sulfonate molecules wherein the mixture has an average carbon number of from 21 to 23 and at least 50% by weight, preferably at least 60% by weight, of the internal olefin sulfonate molecules in the mixture contain from 19 to 23 carbon atoms.

“C₂₀₋₂₄ internal olefin sulfonate” (C₂₀₋₂₄ IOS) as used herein means a mixture of internal olefin sulfonate molecules wherein the mixture has an average carbon number of from 20 to 23 and at least 50% by weight, preferably at least 65% by weight, more preferably at least 75% by weight, most preferably at least 90% by weight, of the internal olefin sulfonate molecules in the mixture contain from 20 to 24 carbon atoms.

“C₂₄₋₂₈ internal olefin sulfonate” (C₂₄₋₂₈ IOS) as used herein means a mixture of internal olefin sulfonate molecules wherein the mixture has an average carbon number of from 24.5 to 27 and at least 40% by weight, preferably at least 45% by weight, of the internal olefin sulfonate molecules in the mixture contain from 24 to 28 carbon atoms.

Further, for the internal olefin sulfonates which are substituted by sulfonate groups, the cation may be any cation, such as an ammonium, alkali metal or alkaline earth metal cation, preferably an ammonium or alkali metal cation.

An IOS molecule is made from an internal olefin molecule whose double bond is located anywhere along the carbon chain except at a terminal carbon atom. Internal olefin molecules may be made by double bond isomerization of alpha olefin molecules whose double bond is located at a terminal position. Generally, such isomerization results in a mixture of internal olefin molecules whose double bonds are located at different internal positions. The distribution of the double bond positions is mostly thermodynamically determined. Further, that mixture may also comprise a minor amount of non-isomerized alpha olefins. Still further, because the starting alpha olefin may comprise a minor amount of paraffins (non-olefinic alkanes), the mixture resulting from alpha olefin isomeration may likewise comprise that minor amount of unreacted paraffins.

The amount of alpha olefins in the internal olefin may be up to 5%, for example 1 to 4 wt. % based on total composition. Further, the amount of paraffins in the internal olefin may be up to 2 wt. %, for example up to 1 wt. % based on total composition.

Suitable processes for making an internal olefin include those described in U.S. Pat. No. 5,510,306; U.S. Pat. No. 5,633,422; U.S. Pat. No. 5,648,584; U.S. Pat. No. 5,648,585; U.S. Pat. No. 5,849,960; and EP 0830315.

In the sulfonation step, the internal olefin is contacted with a sulfonating agent The reaction of the sulfonating agent with an internal olefin leads to the formation of cyclic intermediates known as beta-sultones, which can undergo isomerization to unsaturated sulfonic acids and the more stable gamma- and delta-sultones.

In a next step, sulfonated internal olefin from the sulfonation step is contacted with a base containing solution. In this step, beta-sultones are converted into beta-hydroxyalkane sulfonates, whereas gamma- and delta-sultones are converted into gamma-hydroxyalkane sulfonates and delta-hydroxyalkane sulfonates, respectively. A portion of the hydroxyalkane sulfonates may be dehydrated into alkene sulfonates.

An IOS comprises a range of different molecules, which may differ from one another in terms of carbon number, being branched or unbranched, number of branches, molecular weight and number and distribution of functional groups such as sulfonate and hydroxyl groups. An IOS comprises both hydroxyalkane sulfonate molecules and alkene sulfonate molecules and possibly also di-sulfonate molecules. Di-sulfonate molecules originate from a further sulfonation of for example an alkene sulfonic acid.

The IOS may comprise at least 30% hydroxyalkane sulfonate molecules, up to 70% alkene sulfonate molecules and up to 15% di-sulfonate molecules. Suitably, the IOS comprises from 40% to 95% hydroxyalkane sulfonate molecules, from 5% to 50% alkene sulfonate molecules and from 0% to 10% di-sulfonate molecules. Beneficially, the IOS comprises from 50% to 90% hydroxyalkane sulfonate molecules, from 10% to 40% alkene sulfonate molecules and from less than 1% to 5% di-sulfonate molecules. More beneficially, the IOS comprises from 70% to 90% hydroxyalkane sulfonate molecules, from 10% to 30% alkene sulfonate molecules and less than 1% di-sulfonate molecules. The composition of the IOS may be measured using a mass spectrometry technique.

U.S. Pat. No. 4,183,867; U.S. Pat. No. 4,248,793 and EP 0351928 disclose processes which can be used to make internal olefin sulfonates.

The hydrocarbon recovery composition additionally comprises an alcohol alkoxy sulfate which is a compound of the formula (I)

R—O—[PO]ₓ[EO]_{y}—X Formula (I)

wherein R is a hydrocarbyl group, PO is a propylene oxide group, EO is an ethylene oxide group, x is the number of propylene oxide groups, y is the number of ethylene oxide groups; and X is a group comprising a sulfate moiety.

The hydrocarbyl group R in formula (I) is preferably aliphatic. When the hydrocarbyl group R is aliphatic, it may be an alkyl group, cycloalkyl group or alkenyl group, suitably an alkyl group. The hydrocarbyl group is preferably an alkyl group. The hydrocarbyl group may be substituted by another hydrocarbyl group as described hereinbefore or by a substituent which contains one or more heteroatoms, such as a hydroxy group or an alkoxy group.

The non-alkoxylated alcohol R—OH, from which the hydrocarbyl group R in the above formula (I) originates, may be an alcohol containing 1 hydroxyl group (mono-alcohol) or an alcohol containing of from 2 to 6 hydroxyl groups (poly-alcohol). Suitable examples of poly-alcohols are diethylene glycol, dipropylene glycol, glycerol, pentaerythritol, trimethylolpropane, sorbitol and mannitol. The hydrocarbyl group R in the above formula (I) preferably originates from a non-alkoxylated alcohol R—OH which only contains 1 hydroxyl group (mono-alcohol). Further, the alcohol may be a primary or secondary alcohol, preferably a primary alcohol.

The non-alkoxylated alcohol R—OH, wherein R is an aliphatic group and from which the hydrocarbyl group R in the above formula (I) originates, may comprise a range of different molecules which may differ from one another in terms of carbon number for the aliphatic group R, the aliphatic group R being branched or unbranched, the number of branches for the aliphatic group R, and the molecular weight. Generally, the hydrocarbyl group R may be a branched hydrocarbyl group or an unbranched (linear) hydrocarbyl group. Further, the hydrocarbyl group R is preferably a branched hydrocarbyl group which has a branching index equal to or greater than 0.3.

The hydrocarbyl group R in the above formula (I) is preferably an alkyl group. The alkyl group has a weight average carbon number within a wide range, namely 5 to 32, more suitably 6 to 25, more suitably 7 to 22, more suitably 8 to 20, most suitably 9 to 17. In a case where the alkyl group contains 3 or more carbon atoms, the alkyl group is attached either via its terminal carbon atom or an internal carbon atom to the oxygen atom, preferably via its terminal carbon atom. Further, the weight average carbon number of the alkyl group is at least 5, preferably at least 6, more preferably at least 7, more preferably at least 8, more preferably at least 9, more preferably at least 10, more preferably at least 11, most preferably at least 12. Still further, the weight average carbon number of the alkyl group is at most 32, preferably at most 25, more preferably at most 20, more preferably at most 17, more preferably at most 16, more preferably at most 15, more preferably at most 14, most preferably at most 13.

Further, the alkyl group R in the above formula (I) is preferably a branched alkyl group which has a branching index equal to or greater than 0.3. The branching index of the alkyl group R in the above formula (I) is preferably of from 0.3 to 3.0, most preferably 1.2 to 1.4. Further, the branching index is at least 0.3, preferably at least 0.5, more preferably at least 0.7, more preferably at least 0.9, more preferably at least 1.0, more preferably at least 1.1, most preferably at least 1.2. Still further, the branching index is preferably at most 3.0, more preferably at most 2.5, more preferably at most 2.2, more preferably at most 2.0, more preferably at most 1.8, more preferably at most 1.6, most preferably at most 1.4.

The alkylene oxide groups in the above formula (I) comprise ethylene oxide (EO) groups or propylene oxide (PO) groups or a mixture of ethylene oxide and propylene oxide groups. In addition, other alkylene oxide groups may be present, such as butylene oxide groups. Preferably, the alkylene oxide groups consist of ethylene oxide groups or propylene oxide groups or a mixture of ethylene oxide and propylene oxide groups. In case of a mixture of different alkylene oxide groups, the mixture may be random or blockwise, preferably blockwise. In the case of a blockwise mixture of ethylene oxide and propylene oxide groups, the mixture preferably contains one EO block and one PO block, wherein the PO block is attached via an oxygen atom to the hydrocarbyl group R.

In the above formula (I), x is the number of propylene oxide groups and is of from 0 to 80. The average value for x is of from 1 to 80, preferably of from 20 to 50, and more preferably from 35 to 50. The average number of propylene oxide groups is referred to as the average PO number.

Further, in the above formula (I), y is the number of ethylene oxide groups and is of from 0 to 60. The average value for y is of from 1 to 80, preferably of from 20 to 50, and more preferably from 35 to 50. The average number of ethylene oxide groups is referred to as the average EO number.

In the above formula (I), the sum of x and y is the number of propylene oxide and ethylene oxide groups and is of from 5 to 150. The average value for the sum of x and y is of from 5 to 90, and may be of from 20 to 60, or of from 30 to 55.

In the above formula (I), y may be 0, in which case the alkylene oxide groups in the above formula (I) comprise PO groups but no EO groups. In the latter case, the average value for the sum of x and y equals the above-described average value for x.

In the above formula (I), x may be 0, in which case the alkylene oxide groups in the above formula (I) comprise EO groups but no PO groups. In the latter case, the average value for the sum of x and y equals the above-described average value for y.

Further, in the above formula (I), each of x and y may be at least 1, in which case the alkylene oxide groups in the above formula (I) comprise PO and EO groups. In the latter case, the average value for the sum of x and y may be of from 1 to 80, suitably of from 20 to 60, and more suitably of from 35 to 50.

The alcohol alkoxy sulfate of the above formula (I) may be a liquid, a waxy liquid or a solid at 20° C. In particular, it is preferred that at least 50 wt. %, suitably at least 60 wt. %, more suitably at least 70 wt. % of the alcohol alkoxy sulfate is liquid at 20° C. Further, in particular, it is preferred that of from 50 to 100 wt. %, suitably of from 60 to 100 wt. %, more suitably of from 70 to 100 wt. % of the alcohol alkoxy sulfate is liquid at 20° C.

The non-alkoxylated alcohol R—OH, from which the hydrocarbyl group R in the above formula (I) originates, may be prepared in any way. For example, a primary aliphatic alcohol may be prepared by hydroformylation of a branched olefin. Preparations of branched olefins are described in U.S. Pat. No. 5,510,306; U.S. Pat. No. 5,648,584 and U.S. Pat. No. 5,648,585, Preparations of branched long chain aliphatic alcohols are described in U.S. Pat. No. 5,849,960; U.S. Pat. No. 6,150,222; U.S. Pat. No. 6,222,077.

The above-mentioned (non-alkoxylated) alcohol R—OH, from which the hydrocarbyl group R in the above formula (I) originates, may be alkoxylated by reacting with alkylene oxide in the presence of an appropriate alkoxylation catalyst. The alkoxylation catalyst may be potassium hydroxide or sodium hydroxide which are commonly used commercially. Alternatively, a double metal cyanide catalyst may be used, as described in U.S. Pat. No. 6,977,236. Still further, a lanthanum-based or a rare-earth metal-based alkoxylation catalyst may be used, as described in U.S. Pat. No. 5,059,719 and U.S. Pat. No. 5,057,627. The alkoxylation reaction temperature may range from 90° C. to 250° C., suitably 120 to 220° C., and super atmospheric pressures may be used if it is desired to maintain the alcohol substantially in the liquid state.

Preferably, the alkoxylation catalyst is a basic catalyst, such as a metal hydroxide, which catalyst contains a Group IA or Group IIA metal ion. Suitably, when the metal ion is a Group IA metal ion, it is a lithium, sodium, potassium or cesium ion, more suitably a sodium or potassium ion, most suitably a potassium ion. Suitably, when the metal ion is a Group IIA metal ion, it is a magnesium, calcium or barium ion. Thus, suitable examples of the alkoxylation catalyst are lithium hydroxide, sodium hydroxide, potassium hydroxide, cesium hydroxide, magnesium hydroxide, calcium hydroxide and barium hydroxide, more suitably sodium hydroxide and potassium hydroxide, most suitably potassium hydroxide. Usually, the amount of such alkoxylation catalyst is of from 0.01 to 5 wt. %, more suitably 0.05 to 1 wt. %, most suitably 0.1 to 0.5 wt. %, based on the total weight of the catalyst, alcohol and alkylene oxide (i.e. the total weight of the final reaction mixture).

The alkoxylation procedure serves to introduce a desired average number of alkylene oxide units per mole of alcohol alkoxylate, wherein different numbers of alkylene oxide units are distributed over the alcohol alkoxylate molecules. For example, treatment of an alcohol with 7 moles of alkylene oxide per mole of primary alcohol results in the alkoxylation of each alcohol molecule with an average of 7 alkylene oxide groups, although a substantial proportion of the alcohol will have become combined with more than 7 alkylene oxide groups and an approximately equal proportion will have become combined with less than 7. In a typical alkoxylation product mixture, there may also be a minor proportion of unreacted alcohol.

Non-alkoxylated alcohols R—OH, from which the hydrocarbyl group R in the above formula (I) for the alcohol alkoxy sulfate originates, wherein R is a branched alkyl group which has a branching index equal to or greater than 0.3 and which has a weight average carbon number of from 5 to 32, are commercially available. A suitable example of a commercially available alcohol mixture is NEODOL™ 67, which includes a mixture of C₁₆ and C₁₇ alcohols of the formula R—OH, wherein R is a branched alkyl group having a branching index of about 1.3, sold by Shell Chemical LP. NEODOL™ as used throughout this text is a trademark. Shell Chemical LP also manufactures a C₁₂/C₁₃ analogue alcohol of NEODOL™ 67, which includes a mixture of C₁₂ and C₁₃ alcohols of the formula R—OH, wherein R is a branched alkyl group haying a branching index of about 1.3, and which is used to manufacture alcohol alkoxy sulfate (AAS) products branded and sold as ENORDET™ enhanced oil recovery surfactants. Another suitable example is EXXAL™ 13 tridecylalcohol (TDA), sold by ExxonMobil, which is of the formula R—OH wherein R is a branched alkyl group haying a branching index of about 2.9 and having a carbon number distribution wherein 30 wt. % is C₁₂, 65 wt. % is C₁₃ and 5 wt. % is C₁₄. Yet another suitable example is MARLIPAL® tridecylalcohol (TDA), sold by Sasol, which product is of the formula R—OH wherein R is a branched alkyl group having a branching index of about 2.2 and having 13 carbon atoms.

In the above-mentioned embodiments of the invention, the cation may be any cation, such as an ammonium, protonated amine, alkali metal or alkaline earth metal cation, preferably an ammonium, protonated amine or alkali metal cation, most preferably an ammonium or protonated amine cation. Examples of suitable protonated amines are protonated methylamine, protonated ethanolamine and protonated diethanolamine.

The alcohol R—O—[PO]ₓ[EO]_{y}—H may be sulfated by any known method, for example by contacting the alcohol with a sulfating agent including sulfur trioxide, complexes of sulfur trioxide with (Lewis) bases, such as the sulfur trioxide pyridine complex and the sulfur trioxide trimethylamine complex, chlorosulfonic acid and sulfamic acid. The sulfation may be carried out at a temperature of at most 80° C. The sulfation may be carried out at temperature as low as −20° C. For example, the sulfation may be carried out at a temperature from 20 to 70° C., preferably from 20 to 60° C., and more preferably from 20 to 50° C.

The alcohol may be reacted with a gas mixture which in addition to at least one inert gas contains from 1 to 8 vol. %, relative to the gas mixture, of gaseous sulfur trioxide, preferably from 1.5 to 5 vol. %. Although other inert gases are also suitable, air or nitrogen are preferred.

The reaction of the alcohol with the sulfur trioxide containing inert gas may be carried out in falling film reactors. Such reactors utilize a liquid film trickling in a thin layer on a cooled wall which is brought into contact with the gas. Kettle cascades, for example, would be suitable as possible reactors. Other reactors include stirred tank reactors, which may be employed if the sulfation is carried out using sulfamic acid or a complex of sulfur trioxide and a (Lewis) base, such as the sulfur trioxide pyridine complex or the sulfur trioxide trimethylamine complex.

Following sulfation, the liquid reaction mixture may be neutralized using an aqueous alkali metal hydroxide, such as sodium hydroxide or potassium hydroxide, an aqueous alkaline earth metal hydroxide, such as magnesium hydroxide or calcium hydroxide, or bases such as ammonium hydroxide, substituted ammonium hydroxide, sodium carbonate or potassium hydrogen carbonate. The neutralization procedure may be carried out over a wide range of temperatures and pressures. For example, the neutralization procedure may be carried out at a temperature from 0 to 65° C. and a pressure in the range from 100 to 200 kPa.

In addition to the above-described alcohol alkoxy sulfate, wherein the hydrocarbyl group is a branched hydrocarbyl group which has a branching index equal to or greater than 0.3, the hydrocarbon recovery composition may also comprise one or more non-ionic surfactants of the formula (V)

R—O—[EO]_{y}—H Formula (V)

wherein R is a hydrocarbyl group which has a branching index of from 0 to lower than 0.3 and which has a weight average carbon number of from 4 to 25, EO is an ethylene oxide group, y is the number of ethylene oxide groups and is at least 0.5.

The alcohol R—OH used to make the non-ionic surfactant of the formula (V) may be primary or secondary, preferably primary. The hydrocarbyl group R in the formula (V) is preferably aliphatic. When the hydrocarbyl group R is aliphatic, it may be an alkyl group, cycloalkyl group or alkenyl group, suitably an alkyl group. The hydrocarbyl group is preferably an alkyl group.

The weight average carbon number for the hydrocarbyl group R in the formula (V) is not essential and may vary within wide ranges, such as from 4 to 25, suitably 6 to 20, more suitably 8 to 15. Further, the hydrocarbyl group R in the formula (V) may be linear or branched and has a branching index of from 0 to lower than 0.3, suitably of from 0.1 to lower than 0.3.

In the formula (V), y is the number of ethylene oxide groups. The non-ionic surfactant of the formula (V), preferably has an average value for y that is at least 0.5. The average value for y may be of from 1 to 20, more suitably 4 to 16, most suitably 7 to 13.

The weight ratio of (1) the internal olefin sulfonate (IOS) to (2) the above-mentioned non-ionic surfactant of the formula (V) may vary within wide ranges and may be of from 1:100 to 20:100, suitably of from 2:100 to 15:100. Further, the weight ratio of (1) the above-described alcohol alkoxy sulfate of formula (I) wherein the hydrocarbyl group is a branched hydrocarbyl group which has a branching index equal to or greater than 0.3 to (2) the above-mentioned non-ionic surfactant of the formula (V) may also vary within wide ranges and may be of from 1:0.1 to 1:10, suitably of from 1:0.2 to 1:5, more suitably of from 1:0.3 to 1:2.

The above-mentioned, optional non-ionic surfactant of the formula (V) and/or the alcohol alkoxy sulfate of the formula (I) as contained in the hydrocarbon recovery composition may be added during or after preparation of the internal olefin sulfonate. For example, they may be added as a process aid prior to or during either the neutralisation or hydrolysis stages of IOS manufacture, or they may be added after the hydrolysis stage.

Suitable examples of commercially available ethoxylated alcohol mixtures, which can be used as the above-mentioned non-ionic surfactants of the formula (V), include the NEODOL™ alkoxylated alcohols, sold by Shell Chemical Company, including mixtures of ethoxylates of C₉, C₁₀ and C₁₁ alcohols wherein the average value for the number of the ethylene oxide groups is 8 (NEODOL™ 91-8 alcohol ethoxylate); mixtures of ethoxylates of C₁₄ and C₁₅ alcohols wherein the average value for the number of the ethylene oxide groups is 7 (NEODOL™ 45-7 alcohol ethoxylate); and mixtures of ethoxylates of C₁₂, C₁₃, C₁₄ and C₁₅ alcohols wherein the average value for the number of the ethylene oxide groups is 12 (NEODOL™ 25-12 alcohol ethoxylate).

A cosolvent (or solubilizer) may be added to increase the solubility of the surfactants in the hydrocarbon recovery composition and/or in the below-mentioned injectable fluid comprising the composition. Suitable examples of cosolvents are polar cosolvents, including lower alcohols (for example sec-butanol and isopropyl alcohol) and polyethylene glycol. Any amount of cosolvent needed to dissolve the surfactant at a certain salt concentration (salinity) may be easily determined by a skilled person through routine tests.

A hydrotrope may be added to increase the solubility of the surfactants in the hydrocarbon recovery composition and/or in the below-mentioned injectable fluid comprising the composition. Suitable examples of hydrotropes include both aryl and non-aryl compounds. The aryl compounds are generally aryl sulfonates or short-chain alkyl-aryl sulfonates in the form of their alkali metal salts (for example sodium toluene sulfonate, potassium toluene sulfonate, sodium xylene sulfonate, ammonium xylene sulfonate, potassium xylene sulfonate, calcium xylene sulfonate, sodium cumene sulfonate, and ammonium cumene sulfonate). Suitable examples of non-aryl hydrotropes are sulfonates whose alkyl moiety contains from 1 to 8 carbon atoms (for example butane sulfonate and hexane sulfonate).

Viscosity modifiers other than the above-described alkoxylated alcohol and/or alkoxylated alcohol derivative of formula (I) may be used in addition to the alkoxylated alcohol and/or alkoxylated alcohol derivative and be included in the hydrocarbon recovery composition. An embodiment of a viscosity modifier is a linear or branched C₁ to C₆ monoalkylether of mono- or di-ethylene glycol. Suitable examples are diethylene glycol monobutyl ether (DGBE), ethylene glycol monobutyl ether (EGBE) and triethylene glycol monobutyl ether (TGBE). Further, a linear or branched C₁ to C₆ dialkylether of mono-, di- or triethvlene glycol, such as ethylene glycol dibutyl ether (EGDE), may be used as a further viscosity modifier.

The hydrocarbon recovery composition may comprise a base (herein also referred to as “alkali”), preferably an aqueous soluble base, including alkali metal containing bases such as for example sodium carbonate and sodium hydroxide.

In addition to the alcohol alkoxy sulfate and the internal olefin sulfonate, the hydrocarbon recovery composition may comprise one or more compounds that function as a pH buffer. A pH buffer is an aqueous solution comprising a weak acid and its conjugate base or a weak base and its conjugate acid. The pH of the buffer changes very little when a small amount of a strong acid or base is added to the buffer. pH buffer solutions can be used to keep the pH at a substantially constant value in the hydrocarbon recovery composition.

The pH buffer may comprise a base selected from the group consisting of ammonia, trimethyl ammonia, pyridine and other amine containing compounds and ammonium hydroxide. The pH buffer may comprise an inorganic base. Preferred embodiments of inorganic bases are the conjugate bases of boric acid and phosphoric acid.

The pH buffer may comprise an acid selected from the group consisting of formic acid, acetic acid, propanoic acid, butanoic acid, pentanoic acid, hexanoic acid, heptanoic acid, octanoic acid, nonanoic acid, decanoic acid, trichloroacetic acid, hydrofluoric acid, hydrocyanic acid, phosphoric acid, oxalic acid, nitrous acid, benzoic acid, ascorbic acid, boric acid, chromic acid, citric acid, carbonic acid, lactic acid, sulfurous acid, uric acid. The pH buffer may comprise KH₂PO₄, Na₂HPO₄ or mixtures thereof.

In another embodiment, the pH buffer may comprise an acid which has a pKₐ between 6 and 12 and the conjugate base of such acid. The acid/conjugate base mixture may function as a stabilizing buffer. The acid wthich has a pKₐ between 6 and 12 and the conjugate base of such acid, and amounts and concentrations of these, may be any one of those as disclosed in US 2016/0177173.

The hydrocarbon recovery composition may be combined with a hydrocarbon removal fluid to produce an injectable fluid, wherein the hydrocarbon removal fluid 1) comprises water (e.g. a brine) and 2) may comprise divalent cations in any concentration, suitably in a concentration of 100 or more parts per million by weight (ppmw), after which the injectable fluid may be injected into the hydrocarbon containing formation.

The present invention further relates to a method of treating a hydrocarbon containing formation, comprising the following steps:
a) providing a hydrocarbon recovery composition to at least a portion of the formation;
b) allowing the hydrocarbon recovery composition to contact the formation.

A “hydrocarbon containing formation” is defined as a sub-surface hydrocarbon containing formation.

The hydrocarbon containing formation may be a crude oil-bearing formation. Different crude oil-bearing formations or reservoirs differ from each other in terms of crude oil type. First, the API may differ among different crude oils. Further, different crude oils comprise varying amounts of saturates, aromatics, resins and asphaltenes. The 4 components are commonly abbreviated as “SARA”. Further, crude oils comprise varying amounts of acidic and basic components, including naphthenic acids and basic nitrogen compounds. Still further, crude oils comprise varying amounts of paraffin wax. These components are present in heavy (low API) crude oils and light (high API) crude oils. The overall distribution of such components in a crude oil is a direct result of geochemical processes. The properties of the crude oil in the crude oil-bearing formation may differ widely. For example, in respect of the API and the amounts of the above-mentioned crude oil components comprising saturates, aromatics, resins, asphaltenes, acidic and basic components (including naphthenic acids and basic nitrogen compounds) and paraffin wax, the crude oil may be of one of the types as disclosed in WO 2013030140 and US 2016/0177172.

Normally, surfactants for enhanced hydrocarbon recovery are transported to a hydrocarbon recovery location and stored at that location in the form of an aqueous composition containing for example 15 to 70 wt. % surfactant. At the hydrocarbon recovery location, the surfactant concentration of such composition would then be further reduced to 0.05-2 wt. %, by diluting the composition with water or brine, before it is injected into a hydrocarbon containing formation. By such dilution with water or brine, an aqueous fluid is formed which fluid can be injected into the hydrocarbon containing formation. Advantageously, a more concentrated aqueous composition having an active matter content of for example 40-70 wt. %, as described above, may be transported to the location and stored there, provided the alcohol alkoxy sulfate is added to such more concentrated aqueous composition, such that the weight ratio of the alcohol alkoxy sulfate to the internal olefin sulfonate is below 1:1. A further advantage is that the water or brine used in such further dilution, which water or brine may originate from the hydrocarbon containing formation (from which hydrocarbons are to be recovered) or from any other source, may have a relatively high concentration of divalent cations, suitably in the above-described ranges. One of the advantages of that is that such water or brine no longer has to be pre-treated (softened) such as to remove the divalent cations, thereby resulting in significant savings in time and costs.

The total amount of the surfactants in the injectable fluid may be of from 0.05 to 2 wt. %, preferably 0.1 to 1.5 wt. %, more preferably 0.1 to 1.2 wt. %, most preferably 0.2 to 1.0 wt. %.

Hydrocarbons may be produced from hydrocarbon containing formations through wells penetrating such formations. “Hydrocarbons” are generally defined as molecules formed primarily of carbon and hydrogen atoms such as oil and natural gas. Hydrocarbons may also include other elements, such as halogens, metallic elements, nitrogen, oxygen and/or sulfur. Hydrocarbons derived from a hydrocarbon containing formation may include kerogen, bitumen, pyrobitumen, asphaltenes, oils or combinations thereof. Hydrocarbons may be located within or adjacent to mineral matrices within the earth. Matrices may include sedimentary rock, sands, silicilytes, carbonates, diatomites and other porous media.

A “hydrocarbon containing formation” may include one or more hydrocarbon containing layers, one or more non-hydrocarbon containing layers, an overburden and/or an underburden. An overburden and/or an underburden includes one or more different types of impermeable materials. For example, overburden/underburden may include rock, shale, mudstone, or wet/tight carbonate (that is to say an impermeable carbonate without hydrocarbons). For example, an underburden may contain shale or mudstone. In some cases, the overburden/underburden may be somewhat permeable. For example, an underburden may be composed of a permeable mineral such as sandstone or limestone.

Properties of a hydrocarbon containing formation may affect how hydrocarbons flow through an underburden/overburden to one or more production wells. Properties include porosity, permeability, pore size distribution, surface area, salinity or temperature of formation. Overburden/underburden properties in combination with hydrocarbon properties, capillary pressure (static) characteristics and relative permeability (flow) characteristics may affect mobilization of hydrocarbons through the hydrocarbon containing formation.

The hydrocarbon containing formation consists of a pore space and a rock matrix. The pore space of the hydrocarbon containing formation contains an aqueous solution called formation water in addition to hydrocarbon fluids. The rock matrix of the hydrocarbon containing formation or reservoir rock is rich in various elements and compounds. In some embodiments, the rock matrix of the hydrocarbon containing formation can act as a pH buffer.

Two distinctly different types of reservoir rock are generally recognized which are elastic formations and carbonate formations. In Lake. Larry, “Enhanced Oil Recovery”, table 3.3 provides an analysis of eight different rocks, seven clastic (sandstone) samples and one carbonate (limestone) sample. The overview demonstrates that quartz (SiO₂) is the main component of elastic formations and the weight percentage of quartz in these samples varies from 64 to 90%. The remaining components include carbonates, clay minerals and feldspars. Carbonates can be present in the form of calcite, ankerite, dolomite, siderite, and/or other carbonate salts and are a source of multivalent ions in the formation water present in the pore space of the hydrocarbon containing formation. Clay minerals are aluminium silicates with molecular lattices that can contain various mono-valent and divalent ions. An important characteristic of clay minerals is that they have a large surface area and have the ability to exchange cations with the formation water. The formation water is generally in equilibrium with the rock matrix at the time of discovery of the hydrocarbon reservoir; an equilibrium which is established over geological time. For example, formation water may contain Na³⁰ , K⁺, Ca²⁺, Mg²⁺, Cl⁻, HCO₃⁻ ions and many other trace ions. The presence of bicarbonate ions at a significant level indicates the pH buffering capacity of the hydrocarbon containing formation.

The temperature of the hydrocarbon containing formation may be in a range of from 60 to 150° C. In one embodiment, the temperature of the hydrocarbon containing formation is in the range of from 80 to 120° C.

The temperature at which AAS can be used can be extended to higher temperatures by combining the AAS with an IOS and using it in a formation where the rock matrix acts as a pH buffer and/or using it with a pH buffer.

The hydrocarbon containing formation typically comprises an aqueous fluid referred to as brine. The brine in the hydrocarbon containing formation may have a total dissolved solids (TDS) of from 1 to 35 wt %.

### EXAMPLES

### Example 1

Several samples were prepared for this experiment to determine the stability of the surfactants at an elevated temperature. To minimize the disturbance to the samples during the long test, sample preparation was performed by generating a batch that was subsequently divided into equal portions in multiple sample containers. From these multiple containers, one sample container was pulled on a periodic basis, analysed and then discarded. The sample containers were fitted with appropriate seals to prevent sample loss via evaporation during testing. In addition, an oxygen scavenger was used along with purging of the sample container headspace with nitrogen before conducting the test.

The majority of the liquid solution was a field representative synthetic brine comprising the following reagents and their concentrations: NaCl (1.5 wt %), KCl (115 ppmw), MgCl₂.6H₂O (130 ppmw), CaCl₂.2H₂O (115 ppmw), and NaHCO₃ (40 ppmw). The mass ratio of rock to liquid solution for the samples containing crushed reservoir rock was 1 to 10. The rock was further crushed and sieved into small particles to help increase the rock surface area. In an actual reservoir, a significantly higher rock surface area is available, which provides a more favourable acid neutralizing or pH buffering environment. The active matter was measured using potentiometric titration and then confirmed using high-performance liquid chromatography.

Samples comprising different components were tested to determine the active matter in the sample at 251, 321 and 399 days at 83° C. The components of the samples and the active matter at the end of the test is reported in Table 1. When AAS and IOS were combined, the weight ratio of AAS to IOS was 3:1. The active matter is reported as the ratio of active matter at the end of the test to the initial active matter. The components were selected from:
AAS—an alcohol alkoxy sulfate having an alkyl chain with 12-13 carbon atoms and an average of 7 propylene oxide groups
IOS—an internal olefin sulfonate having from 20-24 carbon atoms
pH buffer—an ammonium chloride/ammonium hydroxide buffer
reservoir rock

| | | Active matter (C/C₀) | | |
|---|---|---|---|---|
| Sample | Components | 251 days | 321 days | 399 days |
| A | AAS | 0.15 | 0 | 0 |
| B | AAS, IOS | 0.90 | 0.75 | 0.27 |
| C | AAS, IOS, rock | 0.86 | 0.84 | 0.73 |
| D | AAS, IOS, pH buffer | 0.83 | 0.75 | 0.70 |
| E | AAS, IOS, pH buffer, rock | 0.91 | 0.85 | 0.78 |

For the samples that included crushed reservoir rock, it may be possible that some of the active matter loss can be attributed to surfactant adsorption on the crushed reservoir rock.

### Example 2

In this example, acid titration was performed on three different samples. This was conducted to determine the acid/handling and/or pH buffering capability of both the brine and brine:rock combinations. The acid titration was conducted using 0.1 N HCl as the titrant at about 25° C. Sample F was a synthetic brine representative of field brine. Sample G was a decanted synthetic brine that was obtained by soaking the brine in crushed reservoir rock overnight at 83° C. using a 1:10 rock:brine mass ratio and then decanting the brine, Sample H was a synthetic brine mixed with finely crushed reservoir rock (+230 mesh) after soaking overnight at 83° C. using a 1:10 rock:brine mass ratio.

The synthetic brine used in each of the solutions had a 1.62 TDS and was comprised of the following reagents at the given concentrations: NaCl (1.5 wt %), KCl (115 ppmw), MgCl2.6H₂O (130 ppmw), CaCl2.2H2O (115 ppmw), and NaHCO3 (40 ppmw).

The acid titration was performed using a buret, stirrer plate, beaker and or BSG bottles, teflon stir bar, and a calibrated pH probe. The target endpoint for each titration was a pH of 4. Though not entirely the same, we attempted to be consistent in the acid drop rate across the different experiments. The solutions were stirred during titration. Two measurements were performed on the brine-only case to gauge measurement noise. The brine-only case served as a reference as well to determine any influence of the crushed reservoir rock.

The results are as follows:

### Sample F

In the first test, 0.8 mL of 0.1 N HCl was added to 150 g of the synthetic brine with a starting pH of 7.7 until it reached an end pH of 4.1. The pH dropped quickly with the introduction of the acid. In the second test, 0.9 mL of 0.1 N HCl was added to 150 g of the synthetic brine with a starting pH of 7.8 until it reached an end pH 4.1, respectfully. The pH again dropped quickly with introduction of the acid.

### Sample G

In this test, 2.2 mL of 0.1 N HCl was added to 145 g of the decanted synthetic brine with a starting pH of 7.6 until it reached an end pH of 4.2. The pH dropped quickly with introduction of the acid from 7.6 to 6. Relative to the acid titration on Sample F, the pH dropped slowly from 6 to 5 and then from 5 to 4 for Sample G.

### Sample H

In this test, 12.25 mL, of 0.1 N HCl was added to 150 g brine and 15 g of the +230 mesh rock with a starting pH of 7.6. The end pH was approximately 4 after the initial acid introduction. Shortly after the acid introduction was stopped, the pH gradually climbed back up and reached equilibrium at a pH of 7 after a few hours. Additional acid was added and this drop in pH followed by an increase in pH was observed again. The buret was only charged with 12.25 mL of the 0.1 N HCl at the start of this test. The rock+buffer would have consumed additional HCl if it had been available. The initial pH drop was consistent with the acid titration of the decanted brine, but the pH drop was very slow from 5 to 4. The crushed reservoir rock was observed buffering the pH to a neutral pH.

In conclusion, the decanted fluid that has been in contact with the rock overnight requires about double the acid when compared with a sample that has not been contacted with the rock.

The required amount of HCI solution is even greater when the rock is present. This indicates significant buffering capacity of the rock and that the rock can restore the pH to more or less the original pH.

1. A method of treating a hydrocarbon containing formation comprising providing a hydrocarbon recovery composition to at least a portion of the hydrocarbon containing formation and allowing the hydrocarbon recovery composition to contact the formation wherein the hydrocarbon recovery composition comprises one or more alcohol alkoxy sulfates and one or more internal olefin sulfonates.

2. The method of claim 1 wherein the weight ratio of the one or more alcohol alkoxy sulfates to the one or more internal olefin sulfonates is from 5:1 to 1:1.

3. The method of claim 1 wherein the weight ratio of the one or more alcohol alkoxy sulfates to the one or more internal olefin sulfonates is from 3:1 to 1:1.

4. The method of claim 1 wherein a pH buffer is present in the hydrocarbon containing formation.

5. The method of claim 1 wherein the hydrocarbon recovery composition also comprises a pH buffer.

6. The method of claim 5 wherein the pH buffer contains an acid and conjugate base mixture.

7. The method of claim 1 wherein the rock matrix of the hydrocarbon containing formation acts as a pH buffer.

8. The method of claim 7 wherein the rock matrix of the hydrocarbon containing formation contains minerals selected from the group consisting of calcite, dolomite, ankerite, siderite, quartz, feldspar and clays.

9. The method of claim 7 wherein the hydrocarbon recovery composition also comprises a pH buffer.

10. The method of claim 1 wherein the temperature of the hydrocarbon formation is at least 60° C.

11. The method of claim 1 wherein the temperature of the hydrocarbon formation is in the range of from 60 to 150° C.
